(19) United States
(12) Patent Application Publication
(10) Pub. No.: US 2009/0192681 A1
(43) Pub. Date: Jul. 30, 2009

(54) Vehicle Controller and Controlling Method

(75) Inventors: Tsuyoshi Hayashi, Nishikamo-gun (JP); Asako Honda, Toyota-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, Toyota-shi (JP)

(21) Appl. No.: 11/992,851

(22) PCT Filed: Oct. 3, 2006
(86) PCT No.: PCT/JP2006/320163

§ 371 Date: Jun. 12, 2008

(30) Foreign Application Priority Data
Oct. 4, 2005 (JP) 2005-291143

(51) Int. Cl. B60R 21/00

(52) U.S. Cl. 701/45

(57) ABSTRACT

An ECU executes a program including the steps of: detecting a distance to an object; changing over a changeover damper from an inside air circulation to an outside air circulation when a collision is predicted; controlling a power window device to move down a door glass; turning an SMR off when the collision is detected; and controlling the power window device to fully open the door glass.

### TECHNICAL FIELD

The present invention relates to a controller and a controlling method of a vehicle, and particularly to a technique of controlling a vehicle to make a vehicle interior communicate with an outside of the vehicle in a collision.

### BACKGROUND ART

In recent years, as one of measures for environmental issues, a hybrid car, a fuel-cell vehicle, an electric car, and the like that travel by a driving force from a motor are receiving attention. Such a vehicle is mounted with a secondary cell such as a battery. As a secondary cell forming a vehicle driving power supply, there is a lithium-ion cell, for example.

As a vehicle mounted with the lithium-ion cell as a driving power supply, Japanese Patent Laying-Open No. 10-341505, for example, discloses a controller of an electric car, for securing a range by usefully using remaining cell power in the electric car powered by a lithium-ion cell even when outside air temperature is high. The controller of the electric car includes a temperature detector for detecting a cell surface temperature of the lithium-ion secondary cell. The controller for carrying out a control including restriction of output based on the cell surface temperature includes an average output calculating means for obtaining an average output of the cell from a cell temperature rise rate and a depth of discharge when the depth of discharge is a set depth or greater, predicted electric energy calculating means for calculating predicted electric energy used before output starts to be restricted due to the cell surface temperature if the car travels on the average output, a remaining power arithmetic means for performing arithmetic to obtain the remaining cell power, a target average output calculating means for calculating a cell temperature rise rate before the remaining power is completely discharged based on the remaining power and the present cell surface temperature and calculating a target average output corresponding to the cell temperature rise rate when the remaining power is greater than the predicted electric energy, and a cell power restricting means for gradually limiting the cell output toward the target average output.

According to the controller of the electric car disclosed in the above-described official gazette, the target average output before the remaining power is completely discharged is calculated based on the remaining cell power and the present cell surface temperature obtained by the cell surface temperature detector and the cell output is gradually restricted toward the target average output. Therefore, it is possible to delay the conventional output restriction starting timing based on the temperature to thereby prolong a period over which normal traveling can be carried out by that delayed period.

However, the lithium-ion secondary cell mounted in the electric car and disclosed in the above-described official gazette may be connected to a vehicle interior space or the vehicle interior through a duct communicating with the vehicle interior space or the vehicle interior and installed in a luggage room space at a rear portion of the vehicle in some cases in order to efficiently cool the cell with temperature-regulated air in the vehicle interior. The lithium-ion cell possibly produces smoke due to a short circuit in the lithium-ion cell on impact of a collision or the like of the vehicle. If the lithium-ion cell is mounted in such a manner that the vehicle interior and the cell communicate with each other, the produced smoke enters the vehicle interior and therefore ventilation is necessary to exhaust the smoke in the vehicle interior.

### DISCLOSURE OF THE INVENTION

It is an object of the present invention to provide a controller and a controlling method of a vehicle for providing ventilation to exhaust smoke that is possibly generated in a collision of the vehicle.

A controller of a vehicle according to an aspect of the invention is a controller of a vehicle mounted with a battery pack including a lithium-ion cell. The battery pack is provided with a path communicating with a vehicle interior. The controller includes: a collision detecting unit for detecting one of a collision of the vehicle and a state where the collision is predicted; and an operation unit connected to the collision detecting unit. The operation unit controls the vehicle to make the vehicle interior communicate with an outside of the vehicle if one of the collision and the state where the collision is predicted is detected.

With this invention, the operation unit controls the vehicle to make the vehicle interior communicate with the outside of the vehicle if one of the collision and the state where the collision is predicted is detected. As a result, even if an impact is applied on the battery pack due to the collision and smoke is produced from the lithium-ion cell in the battery pack and enters the vehicle interior, the produced smoke can be exhausted out of the vehicle. Therefore, it is possible to provide the vehicle controller for providing ventilation to exhaust the smoke that is possibly produced in the collision of the vehicle.

A controller of a vehicle according to another aspect of the invention is a controller of a vehicle mounted with a battery pack including a lithium-ion cell. The battery pack is provided with a path communicating with a vehicle interior. The controller includes: a collision detecting unit for detecting a state where a collision of the vehicle is predicted; and an operation unit connected to the collision detecting unit. The operation unit estimates possibility of the collision step-by-step based on the detected state and controls the vehicle to make the vehicle interior communicate with an outside of the vehicle according to the estimated possibility of the collision.

With this invention, the operation unit estimates the possibility of the collision step-by-step based on the detected state where the collision of the vehicle is predicted (e.g., a distance between the vehicle and an object, a relative speed, and an acceleration of the vehicle). The operation unit controls the vehicle to make the vehicle interior communicate with an outside of the vehicle if it is estimated that the level of the possibility of the collision of the vehicle is so high that the collision is unavoidable. As a result, it is possible to reliably make the vehicle interior communicate with the outside of the vehicle at an early stage before the collision. Consequently, even if an impact is applied on the battery pack due to the collision and smoke is produced from the lithium-ion cell in the battery pack and enters the vehicle interior, the produced smoke can be exhausted out of the vehicle. Therefore, it is possible to provide the vehicle controller for providing ventilation to exhaust the smoke that is possibly produced in the collision of the vehicle.

The vehicle is preferably provided with an air conditioner having a changeover unit for changing between introducing and not introducing outside air into the vehicle interior. The operation unit controls the changeover unit to introduce the outside air into the vehicle interior.

With this invention, the operation unit controls the changeover unit to introduce the outside air into the vehicle interior to thereby make the vehicle interior communicate with the outside of the vehicle if the collision or the state where the collision is predicted is detected. As a result, even if an impact is applied on the battery pack due to the collision and smoke is produced from the lithium-ion cell in the battery pack and enters the vehicle interior, the produced smoke can be exhausted out of the vehicle through the air conditioner. Therefore, it is possible to provide ventilation to exhaust the smoke that is possibly produced in the collision of the vehicle.

Furthermore, the operation unit preferably controls opening and closing mechanisms provided to the vehicle to open the opening and closing mechanisms.

With this invention, the operation unit controls the opening and closing mechanisms (e.g., window glasses of power window devices) provided to the vehicle to open the opening and closing mechanisms to thereby make the vehicle interior communicate with the outside of the vehicle. As a result, even if an impact is applied on the battery pack due to the collision and smoke is produced from the lithium-ion cell in the battery pack and enters the vehicle interior, the produced smoke can be exhausted out of the vehicle through the open opening and closing mechanisms. Therefore, it is possible to provide ventilation to exhaust the smoke that is possibly produced in the collision of the vehicle.

Moreover, a plurality of seats are preferably provided in the vehicle interior. The controller further includes a seating detecting unit for detecting on which of the plurality of seats an occupant is seated. The operation unit controls the opening and closing mechanism to open the opening and closing mechanism provided in a position corresponding to the detected seat on which the occupant is seated.

With this invention, the occupant is seated on any of the plurality of seats, the operation unit controls the opening and closing mechanism (e.g., the window glass of the power window device) to open the opening and closing mechanism provided in a position corresponding to the detected seat on which the occupant is seated to thereby make the vehicle interior communicate with the outside of the vehicle. As a result, even if an impact is applied on the battery pack due to the collision and smoke is produced from the lithium-ion cell in the battery pack and enters the vehicle interior, the opening and closing mechanism provided in the position around the seat on which the occupant is seated is opened to thereby exhaust the smoke around the occupant out of the vehicle. Therefore, it is possible to provide ventilation to exhaust the smoke that is possibly produced in the collision of the vehicle.

Furthermore, each of the opening and closing mechanisms includes at least one of a power window, an electric roof, and an electric door.

With this invention, even if an impact is applied on the battery pack due to the collision of the vehicle and smoke is produced from the lithium-ion cell, any of the power window, the electric roof, and the electric door is opened to thereby exhaust the smoke that has entered the vehicle interior out of the vehicle. Therefore, it is possible to provide ventilation to exhaust the smoke that is possibly produced in the collision of the vehicle.

Moreover, the vehicle is preferably a vehicle using a motor as a drive source, the motor being powered by the lithium-ion cell.

With this invention, the vehicle is the vehicle using the motor as a drive source, the motor being powered by the lithium-ion cell. Even if an impact is applied on the battery pack due to the collision of such a vehicle and smoke is produced from the lithium-ion cell, the smoke that has entered the vehicle interior can be exhausted out of the vehicle. Therefore, it is possible to provide ventilation to exhaust the smoke that is possibly produced in the collision of the vehicle.

### BRIEF DESCRIPTION OF THE DRAWINGS

FIG. 1 is a side view of a vehicle mounted with a controller of the vehicle according to the present embodiment.

FIG. 2 is a drawing showing a section of the vehicle mounted with the controller of the vehicle according to the embodiment.

FIG. 3 is a drawing showing a structure of the vehicle mounted with the controller of the vehicle according to the embodiment.

FIG. 4 is a flow chart showing a control configuration of a program executed by an ECU that is the controller of the vehicle according to the embodiment.

### BEST MODES FOR CARRYING OUT THE INVENTION

An embodiment of the present invention will be described below with reference to the drawings. In the following description, the same parts are provided with the same reference numerals. They have the same names and functions. Therefore detailed description of them will not be repeated.

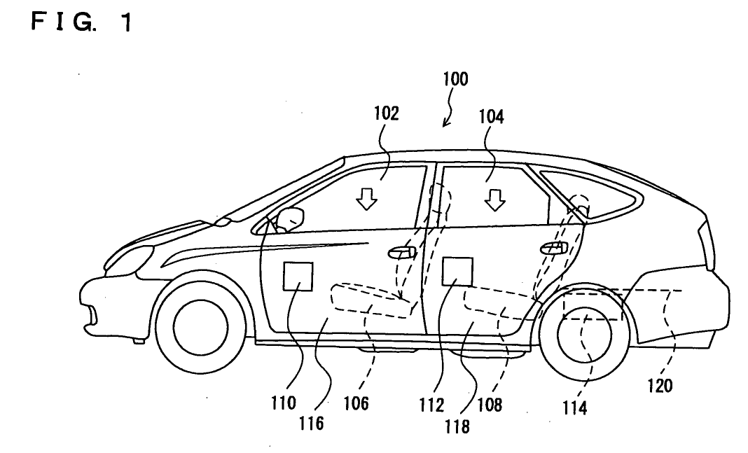

With reference to FIG. 1, a vehicle 100 mounted with a controller of the vehicle according to the embodiment of the invention will be described. Although vehicle 100 is described as a hybrid car in the embodiment, the vehicle to which the invention is applied is not especially restricted to the hybrid car but may be an electric car, for example, if the vehicle at least uses a lithium-ion cell as a vehicle driving power supply.

Vehicle 100 includes a battery pack 114 for supplying electric power to a motor (not shown) for driving vehicle 100, front seats 104, rear seats 108, a power window device 110 provided to a front door 116 to move a door glass 102 up and down in a vertical direction of the vehicle, and a power window device 112 provided to a rear door 118 to move a door glass 104 up and down in the vertical direction of the vehicle.

Battery pack 114 includes a plurality of battery modules (not shown) and each module includes a plurality of battery cells. Each battery cell is a lithium-ion cell. Battery pack 114 is mounted in the vehicle interior of vehicle 100, behind rear seats 108, and under a luggage room floor 120.

In the vehicle interior, front seats 104 are provided on a front side of the vehicle and rear seats 108 are provided on a rear side of the vehicle. Front door 116 is provided with power window device 110 for moving up and down front door glass 102. Power window device 110 moves up and down front door glass 102 by driving an electric motor.

Rear door 118 is provided with power window device 112 for moving up and down rear door glass 104. Power window device 112 moves up and down rear door glass 104 by driving an electric motor.

Although doors 116, 118 provided on a left side of vehicle 100 and power window devices 110, 112 provided to doors 116, 118 have been described in the embodiment, doors 116, 118 and power window devices 110, 112 are also provided on a right side of vehicle 100 to produce a bilaterally symmetric appearance. Detailed description of them will not be repeated.

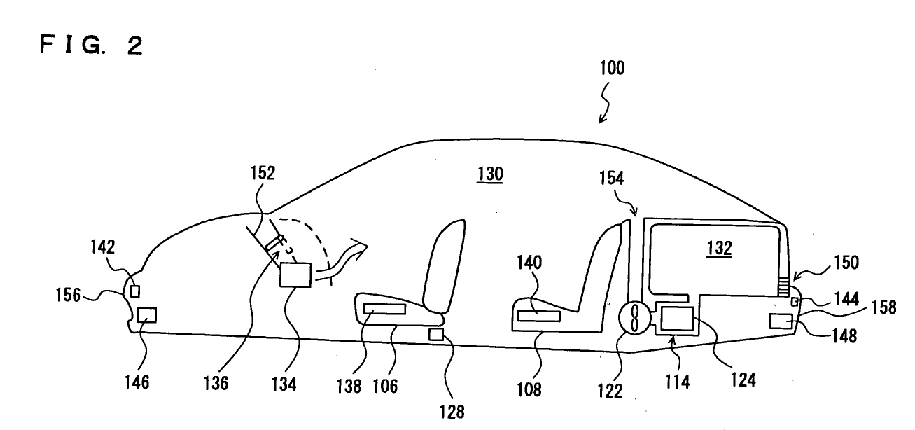

With reference to FIG. 2, vehicle 100 mounted with the vehicle controller according to the embodiment will be further described. Vehicle 100 includes a vehicle interior 130 and a luggage room 132 provided behind vehicle interior 130. Vehicle 100 is a hatchback vehicle having vehicle interior 130 and luggage room 132. In an instrument panel on a front side of vehicle interior 130, an air conditioner unit 134 is provided. Vehicle 100 is not especially restricted to the hatchback vehicle.

Air conditioner unit 134 includes a duct 152 connecting an outside of the vehicle and the vehicle interior and a changeover damper 136 provided midway through duct 152. Air conditioner unit 134 is changed between an outside air introducing mode and an inside air circulating mode by changing a position of changeover damper 136. In other words, in the inside air circulating mode, changeover damper 136 moves to such a position (solid line) as to close duct 152 to cut off the outside of the vehicle and the vehicle interior from each other. In the outside air introducing mode, changeover damper 136 moves to a position (broken line) along a side wall of the duct to make the outside of the vehicle communicate with the vehicle interior.

A cooling fan 122 is provided behind rear seats 108 provided in vehicle interior 130. Behind cooling fan 122, battery modules 124 housed in a housing of battery pack 114 are provided. Cooling fan 122 and the housing of battery pack 114 communicate with each other through the duct. Positions where cooling fan 122 and battery pack 114 are mounted are not restricted to positions behind rear seats 108 but may be positions below front seats 106 or rear seats 108.

Cooling fan 122 communicates with vehicle interior 130 through an inlet 154 open on a rear package tray. Cooling air sent to battery pack 114 is drawn in from inlet 154. Battery pack 114 communicates with luggage room 132 through an outlet. At a rear portion of luggage room 132, a vent 150 is provided. Vent 150 is open toward the outside of the vehicle.

A front bumper 156 and a rear bumper 158 of vehicle 100 are provided with collision detecting sensors 142, 144 for detecting an impact at the time of a collision of vehicle 100. Collision detecting sensors 142, 144 are touch sensors, for example, and transmit a collision detection signal according to the received impact to an ECU (Electronic Control Unit) that will be described later when an object outside the vehicle comes in contact with front bumper 156 or rear bumper 158. Collision detecting sensors 142, 144 are not especially restricted to the touch sensors if they can detect the impact applied to vehicle 100. Alternatively, an air-bag sensor used for an air-bag system may be used as collision detecting sensors 142, 144. Positions where collision detecting sensors 142, 144 are provided are not especially restricted to front bumper 156 and rear bumper 158. For example, they may be provided in battery pack 114.

Moreover, front bumper 156 and rear bumper 158 of vehicle 100 are provided with radar devices 146, 148 for measuring a distance to and a relative speed of an object around vehicle 100. In the embodiment, radar devices 146, 148 are millimeter-wave radars using millimeter waves as detecting waves and are FM-CW radar devices using frequency-modulated (FM) continuous wave (CW) as transmitted signals. Radar devices 146, 148 can detect objects such as vehicles positioned in front of and behind vehicle 100 and simultaneously obtain relative positions (distances) and relative speeds of the objects. Since the FM-CW radar device is a known technique, it will not be described specifically. Radar devices 146, 148 may be also provided to side faces of vehicle 100. Each of radar devices 146, 148 transmits the distance to and the relative speed of the detected object to the ECU.

Although the distance to or the relative speed of the object in front of or behind vehicle 100 is detected by using radar device 146 or 148 in the embodiment, use of the radar device is not absolute necessity. For example, CCD cameras may be used to detect the distance to or the relative speed of the object in front of or behind vehicle 100. As a method of detecting the distance to or the relative speed of the object in front of vehicle 100 by using the CCD cameras, two CCD cameras may be disposed in positions at a distance from each other in a vehicle width direction, e.g., to left and right side mirrors, opposite end portions of a radiator grill, or the like and parallax of the two CCD cameras may be utilized to detect the distance between vehicle 100 and the object and the relative speed of the object, for example. Alternatively, the CCD cameras and above-described radar devices 146, 148 may be combined to detect the distance between vehicle 100 and the object and the relative speed of the object with precision.

Moreover, a G sensor 128 is provided in the vicinity of a central portion of vehicle 100 to detect accelerations in a front-rear direction and the width direction of vehicle 100. G sensor 128 transmits signals representing the detected accelerations to the ECU.

In positions of front seats 106 and rear seats 108 where occupants are seated, occupant detecting sensors 138, 140 are provided, respectively. Occupant detecting sensors 138, 140 output signals indicating that the occupants are seated to the ECU if the occupants are seated in seated positions above occupant detecting sensors 138, 140. In the embodiment, occupant detecting sensors 138 are provided in a driver seat and a passenger seat of front seats 106 and respective seats of rear seats 108. Therefore, the ECU detects the seat on which the occupant is seated based on the seat corresponding to the occupant detecting sensor from which the signal has been output. Alternatively, instead of using occupant detecting sensors 138, 140, an image of the vehicle interior obtained by a camera or the like may be analyzed to detect the seat on which the occupant is seated.

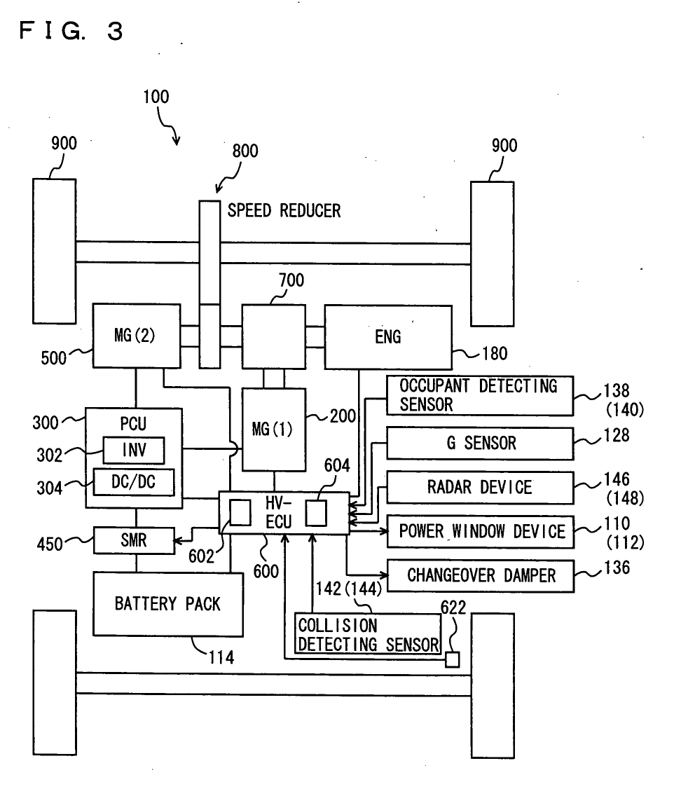

As shown in FIG. 3, vehicle 100 mounted with the controller of the vehicle according to the embodiment includes an engine 180, a motor generator (hereinafter abbreviated as “MG”) (1) 200, a PCU (Power Control Unit) 300, battery pack 114, an MG (2) 500, occupant detecting sensors 138, 140, G sensor 128, radar devices 146, 148, power window devices 110, 112, A/C changeover damper 136, touch sensors 142, 144, a wheel speed sensor 622, and ECU 600 connected to all of them.

Engine 180 burns an air-fuel mixture of fuel and air and rotates a crankshaft (not shown) to generate a driving force. The driving force generated by engine 180 is split by a power split device 700 into two paths. One of them is a path for driving wheels 900 through a speed reducer 800. The other is a path for driving MG (1) 200 to generate electricity.

MG (1) 200 is driven by mechanical power of engine 180 split by power split device 700 to generate electricity. Electric power generated by MG (1) 200 is used properly according to a driving state of the vehicle and an SOC (State Of Charge) of battery pack 114. During normal traveling or abrupt acceleration, for example, the electric power generated by MG (1) 200 is supplied to MG (2) 500 via PCU 300.

On the other hand, if the SOC of battery pack 114 is lower than a predetermined value, the electric power generated by MG (1) 200 is converted from alternating-current electric power into direct-current electric power by an inverter 302 of PCU 300 and stored in battery pack 114 after its voltage is adjusted by a converter 304.

MG (2) 500 is a three-phase AC rotating electrical machine. MG (2) 500 is driven by at least one of the electric power stored in battery pack 114 and the electric power generated by MG (1) 200.

A driving force of MG (2) 500 is transmitted to wheels 900 via speed reducer 800. Thus, MG (2) 500 assists engine 180 to cause the vehicle to travel or causes the vehicle to travel only by the driving force from MG (2) 500.

At a time of regenerative braking of the vehicle, MG (2) 500 is driven by wheels 900 through speed reducer 800 and MG (2) 500 is actuated as a power generator. Thus, MG (2) 500 is actuated as a regenerative brake for converting braking energy into electric power. The electric power generated by MG (2) 500 is stored in battery pack 114 via inverter 302 and converter 304.

Between battery pack 114 and PCU 300, a system main relay 450 (hereinafter referred to as SMR) is provided. SMR 450 is a relay for opening and closing a contact by utilizing electromagnetic force of a coil or the like, for example. Therefore, by controlling (e.g., on/off controlling) electric power supplied to the coil by ECU 600, battery pack 114 and PCU 300 are brought into electric continuity (SMR 450 is ON) with each other or cut off from each other (SMR 450 is OFF).

ECU 600 includes a CPU (central processing unit) 602 and memory 604. CPU 602 performs arithmetic processing based on a traveling state of the vehicle, an accelerator pedal position, a pressed degree of a brake pedal, a shift position, the SOC of battery pack 114, a map, a program, and the like stored in memory 604, and the like. In this way, ECU 600 controls devices mounted in the vehicle to bring the vehicle into a desired operation state. The controller of the vehicle according to the embodiment is implemented by ECU 600.

Changeover damper 136 moves to a position corresponding to selected one of the outside air introducing mode for conditioning air taken in from outside the vehicle and an inside air circulating mode for circulating and conditioning air in the vehicle interior in the vehicle interior when changeover damper 136 receives a control signal from ECU 600.

In the vehicle having the above structure, the invention is characterized in that power window devices 110, 112 are controlled to make vehicle interior 130 communicate with the outside of the vehicle when ECU 600 detects the collision of vehicle 100 or a state where the collision is predicted.

To put it concretely, ECU 600 controls power window devices 110, 112 to move down door glasses 102, 104 when the collision with an object around the vehicle is predicted by radar devices 146, 148 or direct application of an impact on vehicle 100 is detected by collision detecting sensors 142, 144.

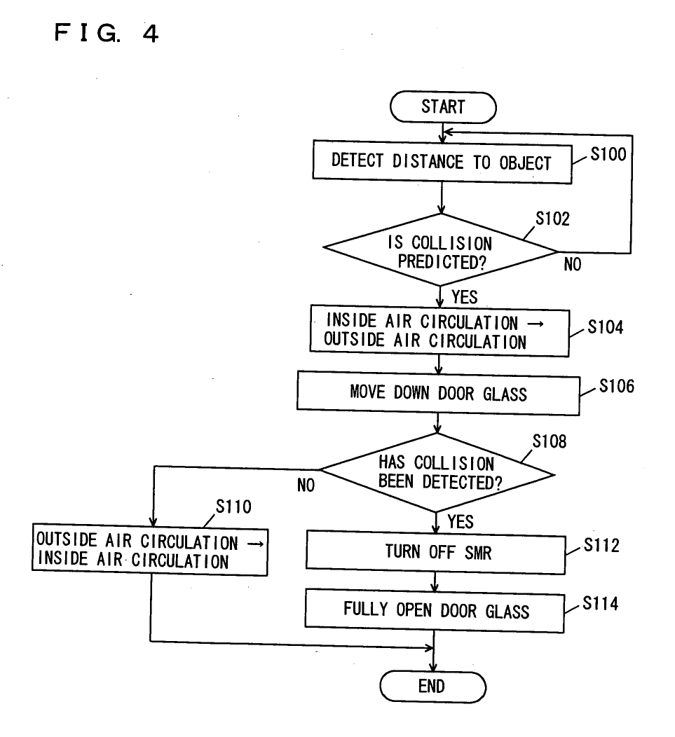

With reference to FIG. 4, a control configuration of the program executed by ECU 600 that is the controller or the vehicle according to the embodiment will be described.

In step (hereinafter abbreviated as “S”) 100, ECU 600 receives a detection signal of a distance to an object. In other words, ECU 600 receives the detection signal representing the distance to the object around vehicle 100 (in the front-rear direction or the width direction of vehicle 100) from radar devices 146, 148.

In S102, ECU 600 determines whether or not it is the state where the collision of vehicle 100 is predicted. To put it concretely, ECU 600 determines whether or not it is the state where the collision of vehicle 100 with the object is predicted based on the detected distance to the object and the relative speed that is a temporal variation of the distance. For example, if the detected distance to the object is within a predetermined distance and the relative speed is a predetermined speed or higher, ECU 600 determines that it is the state where the collision of vehicle 100 with the object is predicted. ECU 600 may predict the collision of vehicle 100 based on the acceleration (deceleration) in the front-rear direction of the vehicle and detected by G sensor 128.

Alternatively, ECU 600 may estimate a possibility of the collision step-by-step based on the detected distance to the object, the relative speed, or the acceleration of vehicle 100 and predict the collision of vehicle 100 according to the estimated possibility. For example, according to the distance to and the relative speed of the object and the acceleration of vehicle 100, the possibility of the collision is set in advance in a plurality of levels (e.g., high, middle, and low). ECU 600 estimates the level of the possibility of the collision based on the detected distance to and the relative speed of the object and the acceleration of vehicle 100. ECU 600 determines that it is the state where the collision of vehicle 100 is predicted if the level of the possibility of the collision is estimated to be high (e.g., the level on which the distance to the object is short, the relative speed and the acceleration (deceleration) of vehicle 100 is high, and the collision of vehicle 100 with the object is unavoidable). The possibility of the collision is not necessarily estimated based on the detected distance to and the relative speed of the object and the acceleration of vehicle 100 but may be estimated in consideration of the traveling state of the vehicle (e.g., a speed and a traveling position), output states from collision detecting sensors 142, 144 (e.g., respective output values of collision detecting sensors 142, 144), and the like. If it is the state where the collision of vehicle 100 is predicted (YES in S102), the processing goes to S104. If not (NO in S102), the processing returns to S100.

In S104, ECU 600 controls changeover damper 136 to move from the position corresponding to the inside air circulating mode to the position corresponding to the outside air circulating mode. In other words, ECU 600 controls changeover damper 136 to make vehicle interior 130 communicate with the outside of the vehicle.

In S106, ECU 600 controls power window devices 110, 112 to open (move down) front door glasses 102 and rear door glasses 104. An amount of opening (amount of moving down) of door glasses 102, 104 may be a predetermined amount or a maximum possible amount and is not especially restricted. It is preferable that ECU 600 controls power window devices 110, 112 to open door glasses 102 or door glasses 104 to reach a predetermined amount of moving down if door glasses 102 or door glasses 104 have moved down in advance.

In S108, ECU 600 determines whether or not vehicle 100 has collided. To put it concretely, ECU 600 determines whether or not vehicle 100 has collided based on the detection signal received from G sensor 128 or collision detecting sensors 142, 144. For example, ECU 600 determines that vehicle 100 has collided when the acceleration (deceleration) of vehicle 100 and received from G sensor 128 is a predetermined value or higher. Alternately, ECU 600 determines that vehicle 100 has collided when the collision detection signals received from collision detecting sensors 142, 144 are predetermined output values or higher. If it is determined that vehicle 100 has collided (YES in S108), the processing goes to S112. If not (NO in S108), the processing goes to S110.

In S110, ECU 600 controls changeover damper 136 to move from the position corresponding to the outside air circulating mode to the position corresponding to the inside air circulating mode. If the outside air circulating mode was selected before the changeover from the position corresponding to the inside air circulating mode to the position corresponding to the outside air circulating mode in S104, the outside air circulating mode may be maintained in S110.

In S112, ECU 600 turns SMR 450 off. In other words, battery pack 114 and PCU 300 are electrically cut off from each other. In S114, ECU 600 controls power window devices 110, 112 to fully open front door glasses 102 and rear door glasses 104 if the glasses have not been fully opened in S106.

Operation of ECU 600 that is the controller of the vehicle according to the embodiment based on the above structure and flow chart will be described.

During traveling of vehicle 100, when a distance to an object in the front-rear direction of vehicle 100 is detected (S100), if the detected distance is within the predetermined distance and the relative speed that is the temporal variation of the distance is the predetermined speed or higher, a collision of vehicle 100 with the object is predicted (YES in S102). At this time, if the inside air circulating mode is selected, changeover damper 136 changes over to the position corresponding to the outside circulating mode (S104). Then, power window devices 110, 112 are controlled to move down front door glasses 102 and rear door glasses 104 to make vehicle interior 130 communicate with the outside of the vehicle (S106).

If collision of vehicle 100 has been detected (YES in S108), SMR 450 is turned off (S112) and power window devices 110, 112 are controlled so that front door glasses 102 and rear door glasses 104 move down to fully open positions. If an impact is applied to battery pack 114 due to the collision of vehicle 100, smoke may be produced from an inside of the lithium-ion cell due to a short circuit in some cases. At this time, if door glasses 102, 104 are fully open, the smoke that has flowed from inlet 42 into vehicle interior 130 flows out of the vehicle through open spaces of door glasses 102, 104 or duct 152. Therefore, an increase in a percentage of smoke to air around the occupants is suppressed or the percentage is reduced.

As described above, with the controller of the vehicle according to the embodiment, even if the impact is applied on the lithium-ion cell due to the collision to produce the smoke and the smoke enters the vehicle interior, the produced smoke can be exhausted out of the vehicle through the open spaces of the door glasses or the duct. Therefore, it is possible to provide the controller of the vehicle for providing ventilation to exhaust the smoke that is possibly produced in the collision of the vehicle.

Although all of the door glasses of the vehicle are controlled to move down when the collision of the vehicle has been detected in the embodiment, the occupant detecting sensors may detect the seats on which the occupants are seated out of the driver and passenger front seats and the respective rear seats and the ECU may control the power window devices to move down the door glasses provided in the positions corresponding to the detected seats (e.g., the door glasses near the seats on which the occupants are seated), for example. In this way, the door glasses near the seats of the occupants open and therefore the smoke that has flowed into the vehicle interior can be exhausted through the open spaces of the door glasses. As a result, it is possible to exhaust the smoke that is possibly produced in the collision of the vehicle.

Although it is the door glasses of the vehicle that open by controlling the power window devices to exhaust the produced smoke out of the vehicle in the description of the embodiment, it is not especially restricted to the door glasses but may be any opening and closing mechanism provided to the vehicle. In other words, if the collision of the vehicle is detected, an electric roof such as a sun roof and a moon roof may be controlled to open, electric doors main be controlled to open, all of the above-mentioned opening and closing mechanisms may be controlled to open, or the opening and closing mechanisms near the occupants may be selectively controlled to open according to the seated positions of the occupants and there is no special restriction.

Between the vehicle interior and the battery pack, a damper or the like may be provided to electrically or mechanically cut off the vehicle interior and the battery pack from each other when an impact is applied on the vehicle due to the collision or the like. In this way, even if smoke is produced by the lithium-ion cell in the battery pack, it is possible to suppress an amount of the smoke flowing into the vehicle interior.

Furthermore, a feeding device for feeding air to the vehicle interior when an impact is applied on the vehicle due to the collision or the like may be provided. In this way, an increase in a percentage of smoke to air around the occupants in the vehicle interior can be suppressed or the percentage can be reduced.

The embodiment disclosed this time is an example in all points and should not be considered restrictive. The scope of the invention is not defined in the above description but is defined in claims and includes meanings equivalent to the claims and all modifications in the scope of claims.

1. A controller for a vehicle mounted with a battery pack including a lithium-ion cell, said battery pack being provided with a path communicating with a vehicle interior, the controller comprising:
a collision detecting unit detecting one of a collision of said vehicle and a state where the collision is predicted; and
an operation unit connected to said collision detecting unit, wherein
said operation unit controls said vehicle to make said vehicle interior communicate with an outside of the vehicle when one of said collision and said state where the collision is predicted is detected.

2. A controller for a vehicle mounted with a battery pack including a lithium-ion cell, said battery pack being provided with a path communicating with a vehicle interior, the controller comprising:
a collision detecting unit detecting a state where a collision of said vehicle is predicted; and
an operation unit connected to said collision detecting unit, wherein
said operation unit estimates possibility of said collision step-by-step based on said detected state, and
controls said vehicle to make said vehicle interior communicate with an outside of the vehicle according to said estimated possibility of the collision.

3. The controller for the vehicle according to claim 1, wherein
said vehicle is provided with an air conditioner having a changeover unit changing between introducing and not introducing outside air into said vehicle interior and
said operation unit controls said changeover unit to introduce said outside air into said vehicle interior.

4. The controller for the vehicle according to claim 3, wherein said vehicle is a vehicle using a motor as a drive source, said motor being powered by said lithium-ion cell.

5. The controller for the vehicle according to claim 1, wherein said operation unit controls opening and closing mechanisms provided to said vehicle to open said opening and closing mechanisms.

6. The controller for the vehicle according to claim 5, wherein a plurality of seats are provided in said vehicle interior,
said controller further comprises a seating detecting unit detecting on which of said plurality of seats an occupant is seated, and
said operation unit controls said opening and closing mechanism to open the opening and closing mechanism provided in a position corresponding to said detected seat on which the occupant is seated.

7. The controller for the vehicle according to claim 5, wherein each of said opening and closing mechanisms includes at least one of a power window, an electric roof, and an electric door.

8. The controller for the vehicle according to claim 5, wherein said vehicle is a vehicle using a motor as a drive source, said motor being powered by said lithium-ion cell.

9. A controller for a vehicle mounted with a battery pack including a lithium-ion cell, said battery pack being provided with a path communicating with a vehicle interior, the controller comprising:
a collision detecting means for detecting one of a collision of said vehicle and a state where the collision is predicted; and
a controlling means for controlling said vehicle to make said vehicle interior communicate with an outside of the vehicle when one of said collision and said state where the collision is predicted is detected.

10. A controller for a vehicle mounted with a battery pack including a lithium-ion cell, said battery pack being provided with a path communicating with a vehicle interior, the controller comprising:
a collision detecting means for detecting a state where s collision of said vehicle is predicted;
an estimating means for estimating possibility of said collision step-by-step based on said detected state; and
a controlling means for controlling said vehicle to make said vehicle interior communicate with an outside of the vehicle according to said estimated possibility of the collision.

11. The controller for the vehicle according to claim 9, wherein said vehicle is provided with an air conditioner having a changeover means for changing between introducing and not introducing outside air into said vehicle interior and
said controlling means includes a means for controlling said changeover means to introduce said outside air into said vehicle interior.

12. The controller for the vehicle according to claim 11, wherein said vehicle is a vehicle using a motor as a drive source, said motor being powered by said lithium-ion cell.

13. The controller for the vehicle according to claim 9, wherein said controlling means includes a means for controlling opening and closing mechanisms provided to said vehicle to open said opening and closing mechanisms.

14. The controller for the vehicle according to claim 13, wherein a plurality of seats are provided in said vehicle interior,
said controller further comprises a means for detecting on which of said plurality of seats an occupant is seated, and
said controlling means includes a means for controlling said opening and closing mechanism to open the opening and closing mechanism provided in a position corresponding to said detected seat on which the occupant is seated.

15. The controller for the vehicle according to claim 13, wherein each of said opening and closing mechanisms includes at least one of a power window, an electric roof, and an electric door.

16. The controller for the vehicle according to claim 13, wherein said vehicle is a vehicle using a motor as a drive source, said motor being powered by said lithium-ion cell.

17. A controlling method of a vehicle mounted with a battery pack including a lithium-ion cell, said battery pack being provided with a path communicating with a vehicle interior and the method including the steps of:
detecting one of a collision of said vehicle and a state where the collision is predicted; and
controlling said vehicle to make said vehicle interior communicate with an outside of the vehicle when one of said collision and said state where the collision is predicted is detected.

18. A controlling method of a vehicle mounted with a battery pack including a lithium-ion cell, said battery pack being provided with a path communicating with a vehicle interior and the method including the steps of:
detecting a state where a collision of said vehicle is predicted;
estimating possibility of said collision step-by-step based on said detected state; and
controlling said vehicle to make said vehicle interior communicate with an outside of the vehicle according to said estimated possibility of the collision.

19. The controlling method of the vehicle according to claim 17, wherein
said vehicle is provided with an air conditioners having a changeover means for changing between introducing and not introducing outside air into said vehicle interior and
said controlling step includes a step of controlling said changeover means to introduce said outside air into said vehicle interior.

20. The controlling method of the vehicle according to claim 19, wherein said vehicle is a vehicle using a motor as a drive source, said motor being powered by said lithium-ion cell.

21. The controlling method of the vehicle according to claim 17, wherein said controlling step includes a step of controlling opening and closing mechanisms provided to said vehicle to open said opening and closing mechanisms.

22. The controlling method of the vehicle according to claim 21, wherein a plurality of seats are provided in said vehicle interior,
said controlling method further includes a step of detecting on which of said plurality of seats an occupant is seated, and
said controlling step includes a step of controlling said opening and closing mechanism to open the opening and closing mechanism provided in a position corresponding to said detected seat on which the occupant is seated.

23. The controlling method of the vehicle according to claim 21, wherein each of said opening and closing mechanisms includes at least one of a power window, an electric roof, and an electric door.

24. The controlling method of the vehicle according to claim 21, wherein said vehicle is a vehicle using a motor as a drive source, said motor being powered by said lithium-ion cell.

25. A controller for a vehicle mounted with a battery pack including a lithium-ion cell, said battery pack being provided with a path communicating with a vehicle interior, the controller comprising:
a radar device for detecting one of a collision of said vehicle and a state where the collision is predicted; and
an electronic control unit, wherein
said electronic control unit controls a power window device or a changeover damper to make said vehicle interior communicate with an outside of the vehicle when one of said collision and said state where the collision is predicted is detected.

26. A controller for a vehicle mounted with a battery pack including a lithium-ion cell, said battery pack being provided with a path communicating with a vehicle interior, the controller comprising:
a radar device for detecting a state where a collision of said vehicle is predicted; and
an electronic control unit, wherein
said electronic control unit estimates possibility of said collision step-by-step based on said detected state and controls a power window device or a changeover damper to make said vehicle interior communicate with an outside of the vehicle according to said estimated possibility of the collision.
